(19) United States
(12) Patent Application Publication
(10) Pub. No.: US 2012/0047455 A1
(43) Pub. Date: Feb. 23, 2012

(54) SYSTEM FOR SOCIAL NETWORKING USING AN EBOOK READER

(75) Inventors: Chang Yuan, Vancouver, WA (US); M. Ibrahim Sezan, Camas, WA (US); Yeping Su, Camas, WA (US)

(73) Assignee: SHARP LABORATORIES OF AMERICA, INC., Camas, WA (US)

(21) Appl. No.: 12/860,781

(22) Filed: Aug. 20, 2010

(51) Int. Cl. G06F 3/14; G06F 3/048

(52) U.S. Cl. 715/781; 715/864

(57) ABSTRACT

An eBook reader that includes the capability of interfacing with a human-centric social network and a book-centric social network.

### CROSS-REFERENCE TO RELATED APPLICATIONS

None

### BACKGROUND OF THE INVENTION

The present invention relates to a system for social networking using an eBook reading device.

The distribution and sharing of information has gained importance with the adoption of personal computers and the Internet. With increased access to the Internet, it has become more feasible to distribute large electronic documents, such as books. The distributed books using the Internet have become commonly referred to as electronic books (“eBooks”).

While reading an eBook on a traditional personal computer attached to a desktop monitor is feasible, the users do not typically have a desirable user experience. eBook based reading devices attempt to generally mimic the experience of a person when they read a conventional book by using a relatively thin form factor that includes an integrated display. A typical eBook reader device is a handheld digital device having a liquid crystal or E-Ink display panel and sufficient computational resources to store a plurality of eBooks. Upon demand, the eBook reader is capable of retrieving and displaying, in a page by page manner, an eBook for reading by the user.

In relation to traditional paper books, an eBook reader is often capable of storing multiple books (e.g., unabridged eBooks) that can be read when desired, in a compact manner that is easily transported. In some cases, eBook readers enable the reader to share limited information with others through their account on a social networking website, such as Facebook.

### BRIEF DESCRIPTION OF THE SEVERAL VIEWS OF THE DRAWINGS

FIG. 1 illustrates an eBook reader.

FIG. 2 illustrates components of an eBook reader.

FIG. 3 illustrates a touch-screen eBook reader.

FIG. 4 illustrates an eBook reader menu.

FIG. 5 illustrates an eBook with a social networking window.

FIG. 6 illustrates a social networking service.

FIG. 7 illustrates basic information for a social networking service.

FIG. 8 illustrates profile picture for a social networking service.

FIG. 9 illustrates relationships for a social networking service.

FIG. 10 illustrates likes and interests for a social networking service.

FIG. 11 illustrates education and work for a social networking service.

FIG. 12 illustrates contact information for a social networking service.

FIG. 13 illustrates social networks.

FIG. 14 illustrates eBook reader to a book-centric social network selection.

FIG. 15 illustrates eBook reader collecting updates from social networks.

FIG. 16 illustrates a content feedback integration program.

FIG. 17 illustrates a geo-mapping program.

FIG. 18 illustrates a reading progress tracker.

FIG. 19 illustrates a reader's choice selection.

### DETAILED DESCRIPTION OF PREFERRED EMBODIMENT

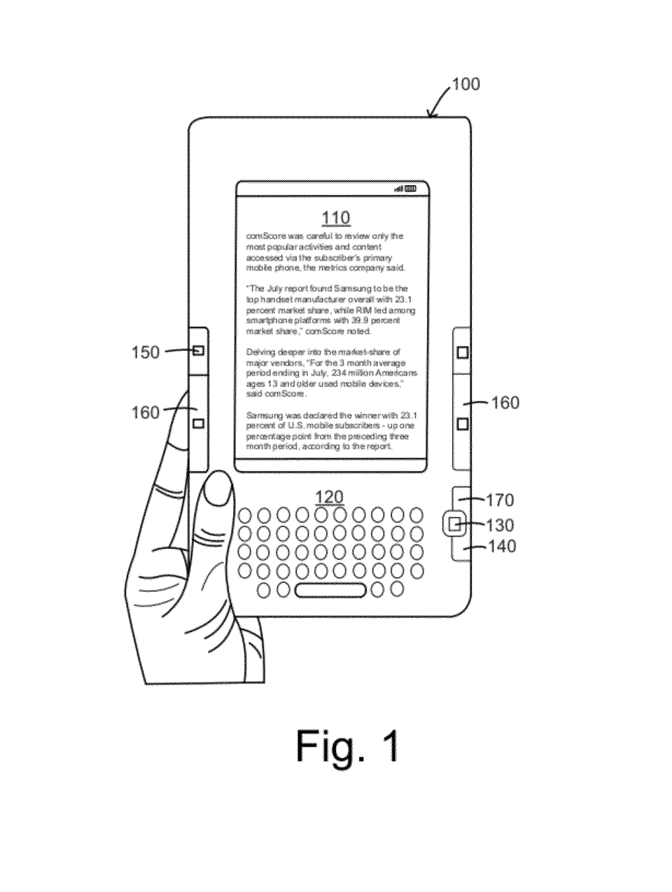

Referring to FIG. 1, an exemplary eBook reader 100 may have a multitude of form factors, although preferably the reader 100 is relatively thin with a front facing integrated display 110. Other foam factors may likewise be used, such as cellular phones and tablets. The display 100 is preferably flat and may be any suitable technology, such as LCD (active or passive), OLED, E-Ink, or otherwise. The reader 100 may also include a keyboard 120 that preferably includes alphanumeric keys. Alternatively, the keyboard 120 may by provided using a “virtual keyboard” that is accessible by a touch screen interface on the display 110. In either case, a user of the reader 100 may enter text into the reader 100 by using the keyboard. The reader 100 may include a selection button 130 that selects items or highlight items, in a manner similar to clicking a mouse button on a personal computer. The reader 100 may likewise include a menu of functions and options displayed on the display 110 that may be accessed, such as by the activation of a menu button 170. When navigating through different menu choices, the selection button 130 may be used in conjunction with the back button 140, and thus proving the ability to navigate nested menus shown on the display 110, together with selecting a desired menu item using the selection button 130.

The reader 100 may further include software and/or firmware which allows for the presentation of electronic books on the display 110. The books may be presented a single page at a time, a part of a single page at a time, two pages at a time, multiple pages at a time, in a scrollable manner, or otherwise in any suitable manner. In this way, an electronic book may be presented to the user in a manner that is suitable for reading the book. The user may scroll to the previous page, or otherwise the next page, by using a previous page button 150, and a next page button 160, respectively, to effectively turn the pages (or otherwise select different pages or portions thereof) of the eBook. While using the reader 100 the menu button 170 may be selected to switch from the book reading software application to a menu application/selection or otherwise activate a selection menu shown on part of the display 110 from within the book reading application.

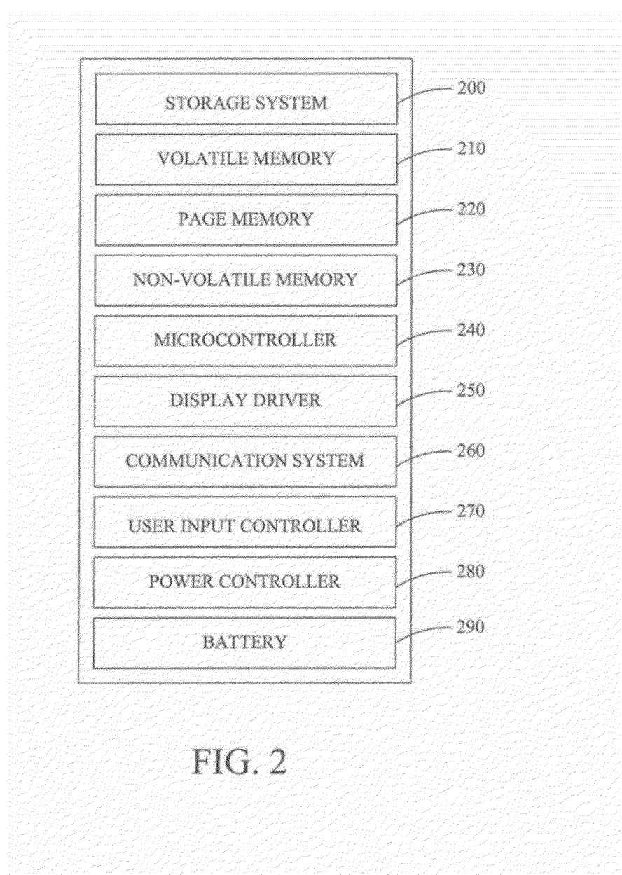

Referring to FIG. 2, the reader 100 may include a storage system 200, that includes a volatile memory 210 suitable for storing the book currently being read and a page memory 220 suitable for the page(s) of the book currently being viewed. The storage system 200 may also include non-volatile memory 230 for the storage of books, other data, and software. The reader 100 likewise may include suitable control circuitry for operation of the device, such as a microcontroller 240, a display driver 250, a communication system 260, user input controller 270, a power controller 280, and a battery 290. Other electronic components may likewise be included, as desired. The communication system 260 may include, for example, USB communication for USB ports, IR communication for IR ports, wireless communication, Bluetooth communication, cellular communication, or any other type of other type of communication to send and receive data for the reader 100. One example of such a device is referred to as the Kindle® available from Amazon.com, Inc.

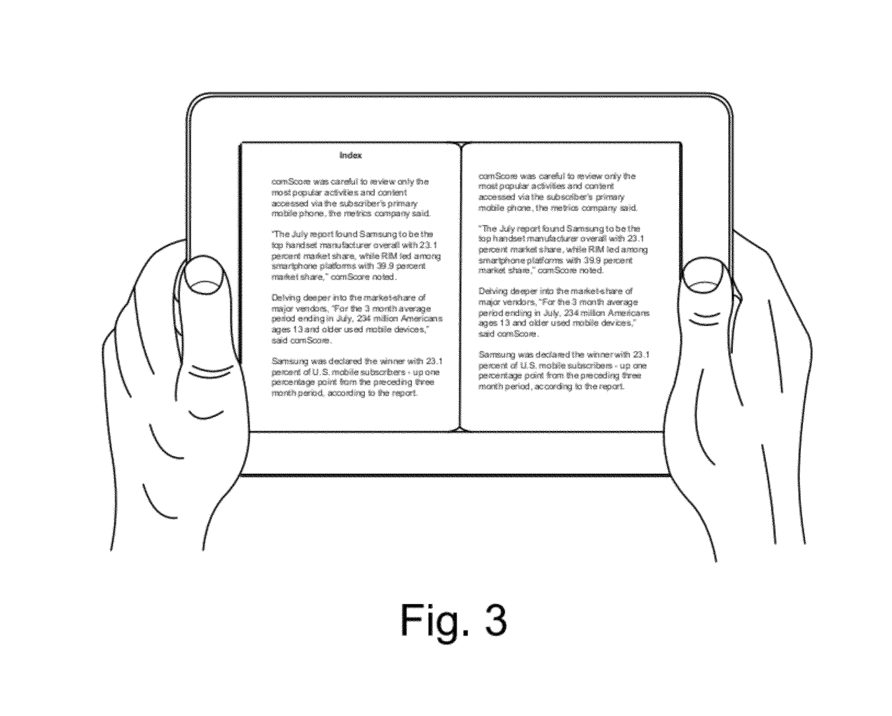

Referring to FIG. 3, in some cases the eBook reader may include a touch screen that provides the primary interface with applications of the device, such as the eBook reading application. The menu selections, page turning, and other functions are operated by primarily using the touch screen as the interface. One example of such a touch screen eBook reading device is referred to as an iPad® available from Apple Inc.

While reading a book in isolation without any interaction with others is sometimes a desirable activity, it is also desirable to share your experiences with others while you are reading the book. The sharing of the reading experience of an eBook provides an enhanced reading experience. One manner of sharing your experiences is through a network connected human-centric social network, such as Facebook®, Myspace®, Twitter®, or any other social networking service. A human-centric social network may be any type of website or network accessible service that can be used to share information with another.

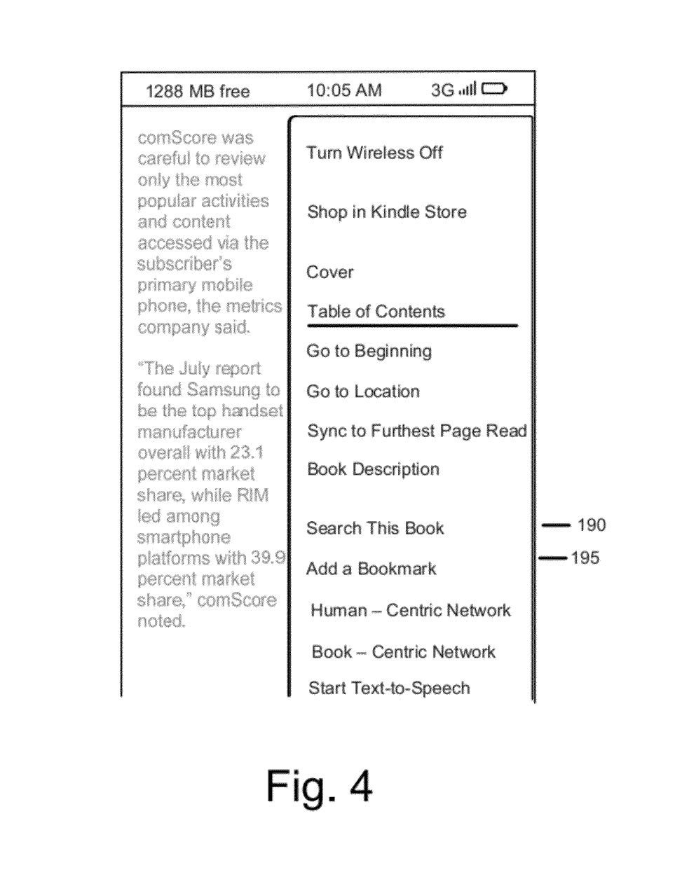

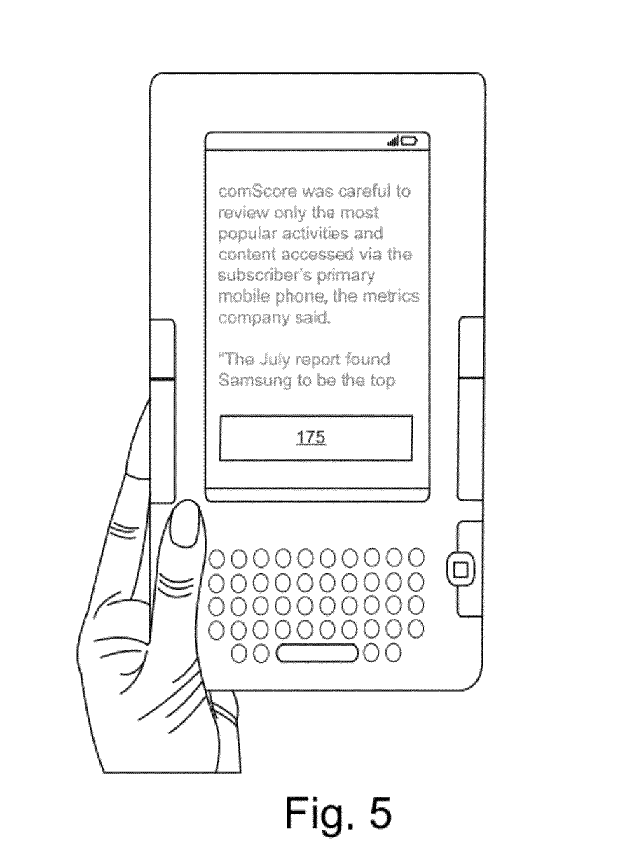

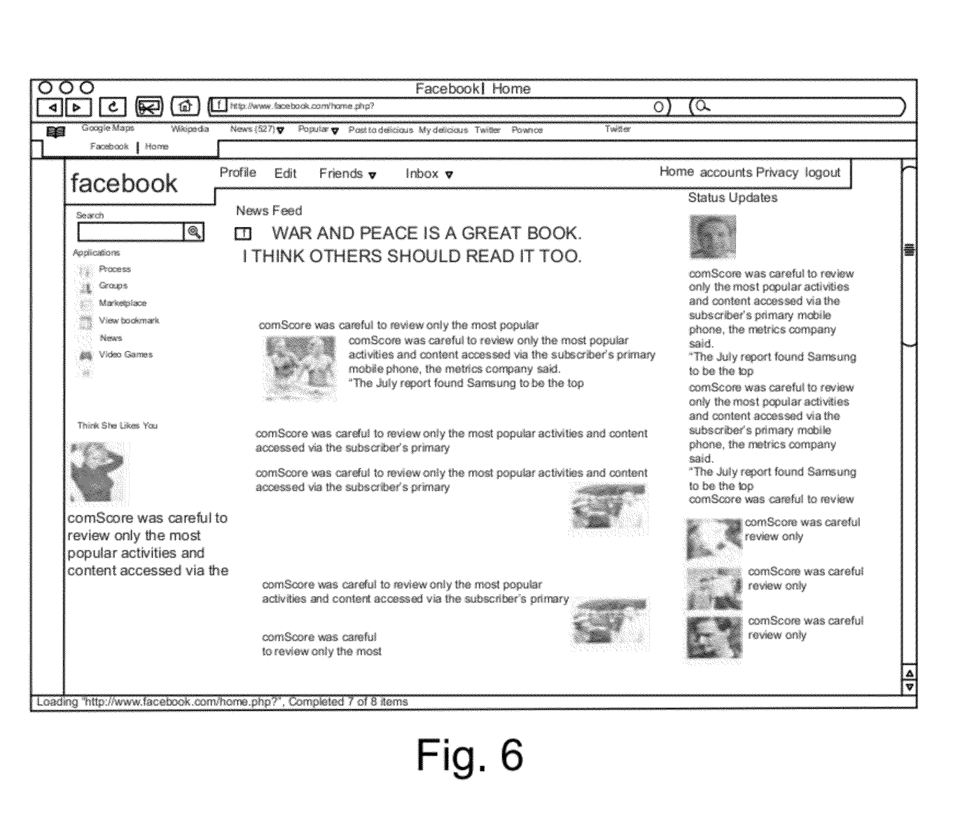

Referring to FIG. 4, while reading your eBook on the reader 100 using an eBook reading application you may select the menu button 170 (or other suitable mechanism) to provide an integrated human-centric social networking option 190 from within the environment of the eBook application (an integrated book-centric social networking option 195 is described below). Accordingly, from within the eBook application, or otherwise the interface encompassing the eBook application, a social networking integration window is provided 175 (see FIG. 5). In this manner users of the eBook application do not need to close or otherwise minimize their eBook reading application to switch to a different social networking application to share their experiences or comments on the content of the book with others. In the social networking window, the user may enter text or other information to be posted to an associated social networking website (human centric or book centric). An example of such a human-centric social networking website is illustrated in FIG. 6, with a reader experience being shared about the book “War and Peace”.

The human-centric networks are generally online social networks that readers frequently use to view and post information about various types of activities. The human-centric networks exist for a long period of time and are built based on a circle of family, friends, and beyond. The nature of the human centric social networks is that the users are not generally anonymous, typically providing their real names and other personal information.

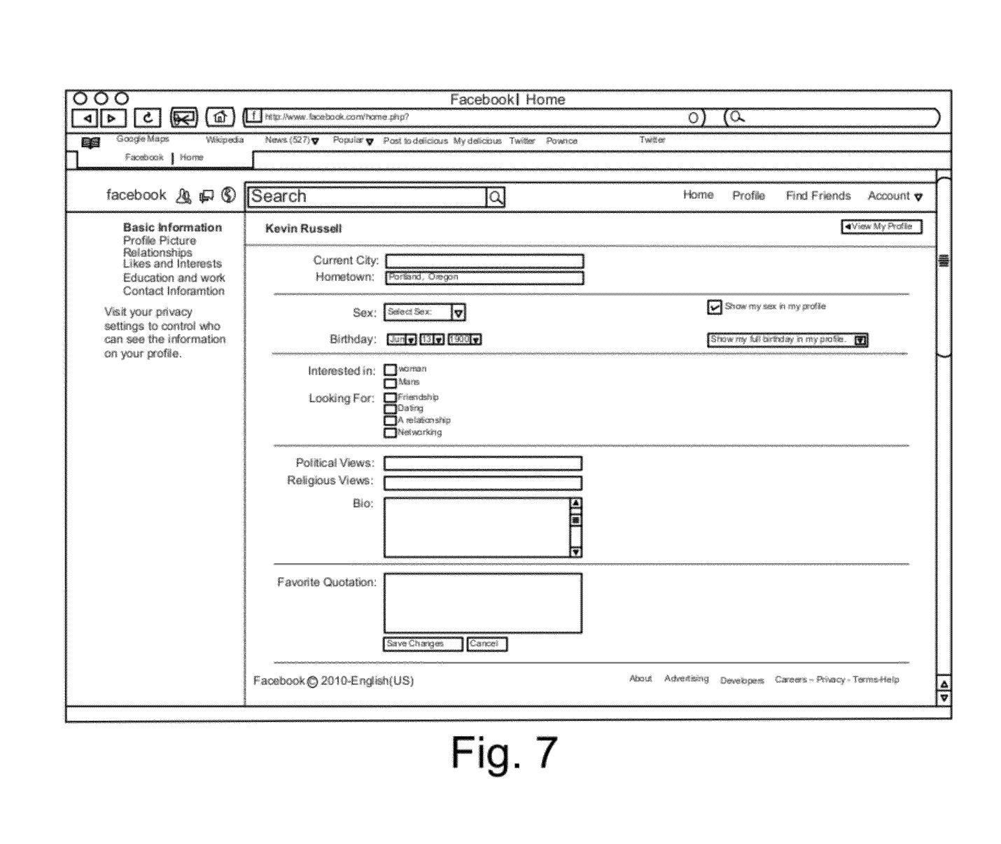

Referring to FIG. 7, a Facebook account may include: Basic Information: (1) current city, (2) hometown, (3) sex, (4) birthday, (5) interested in women and/or men, (6) looking for friendship and/or dating and/or a relationship and/or networking, (7) political views, (8) religious views, (9) bio, and (10) favorite quotations.

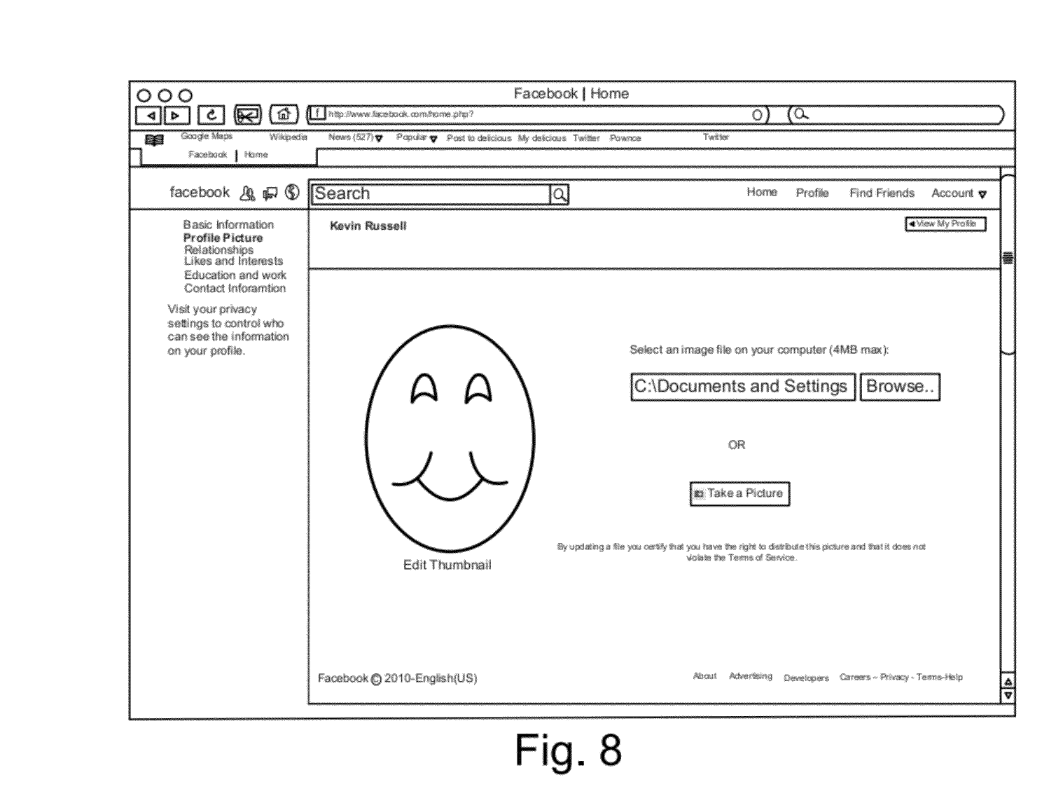

Referring to FIG. 8, a Facebook account may include: a Profile picture that includes your profile picture.

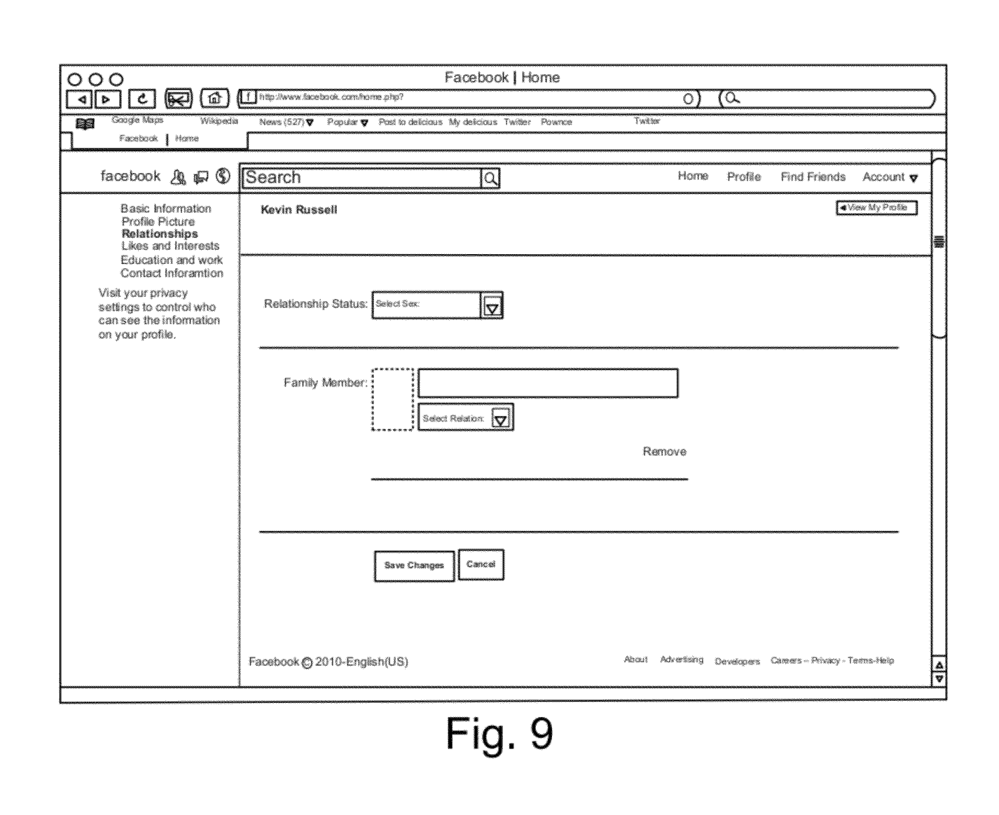

Referring to FIG. 9, a Facebook account may include: Relationships that includes (1) your relationship status (in a relationship/engaged/married/it's complicated/in an open relationship/widowed) with another, together with your (2) anniversary, and other (3) family members.

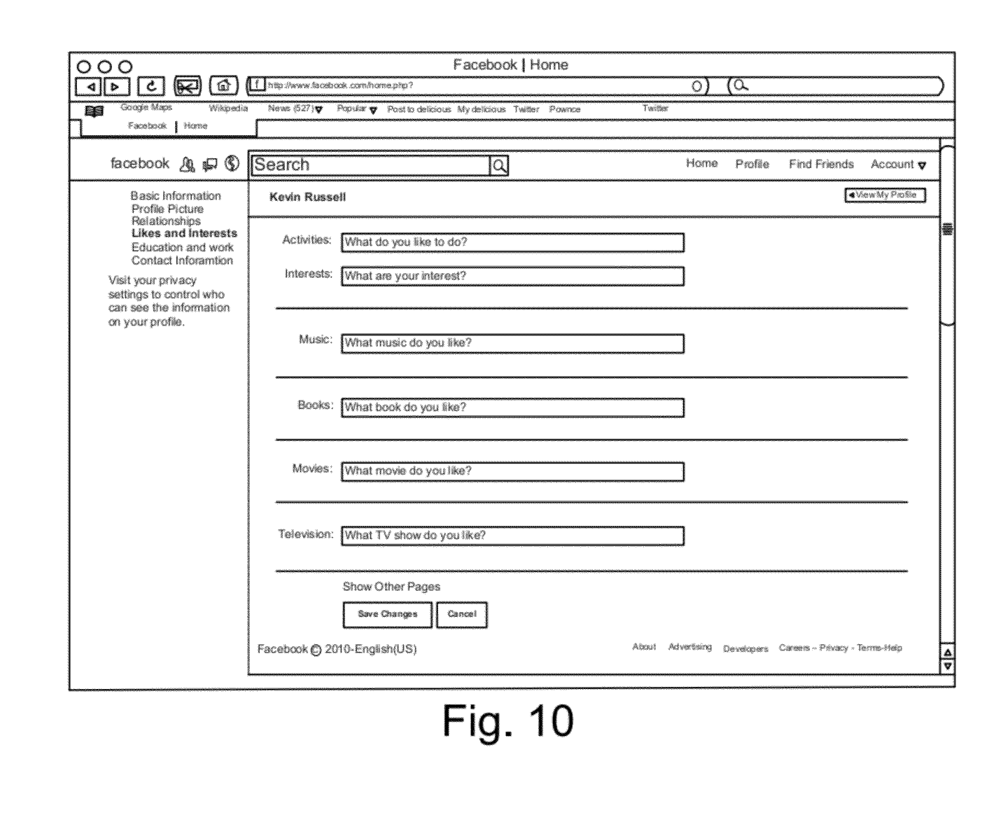

Referring to FIG. 10, a Facebook account may include: Likes and Interests: (1) activities, (2) interests, (3) music, (4) books, (5) movies, and (6) television.

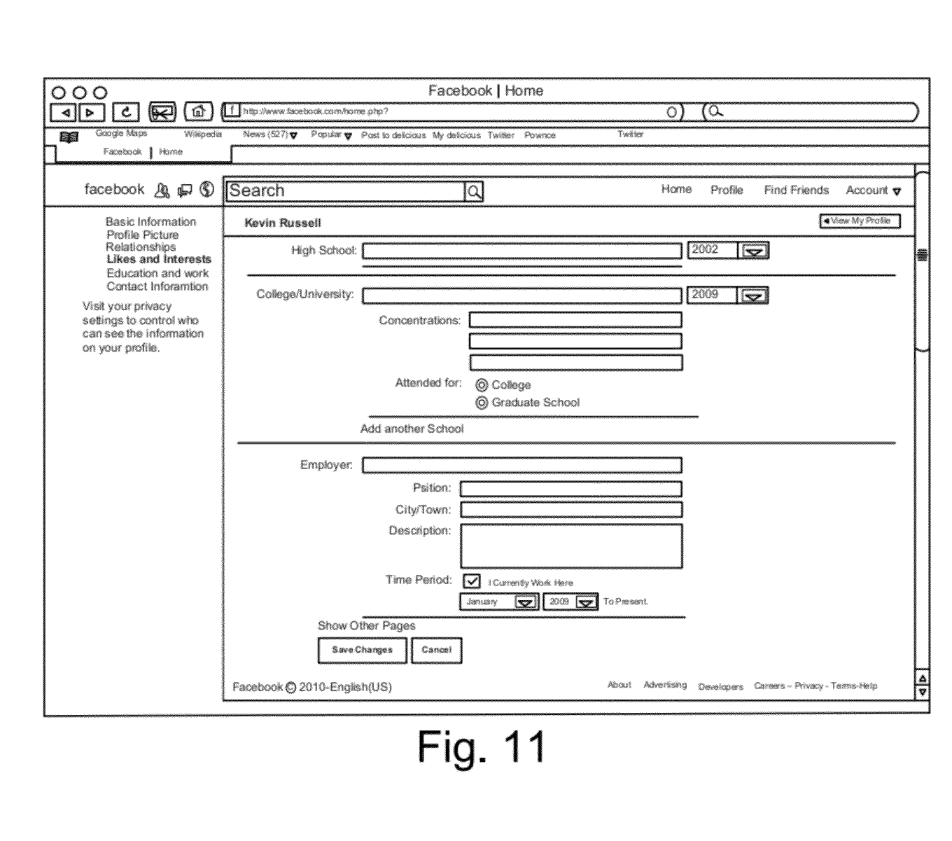

Referring to FIG. 11, a Facebook account may include: Education and Work: (1) high school, (2) college/university with concentrations, and (3) employer with position, city/town, description, and time period.

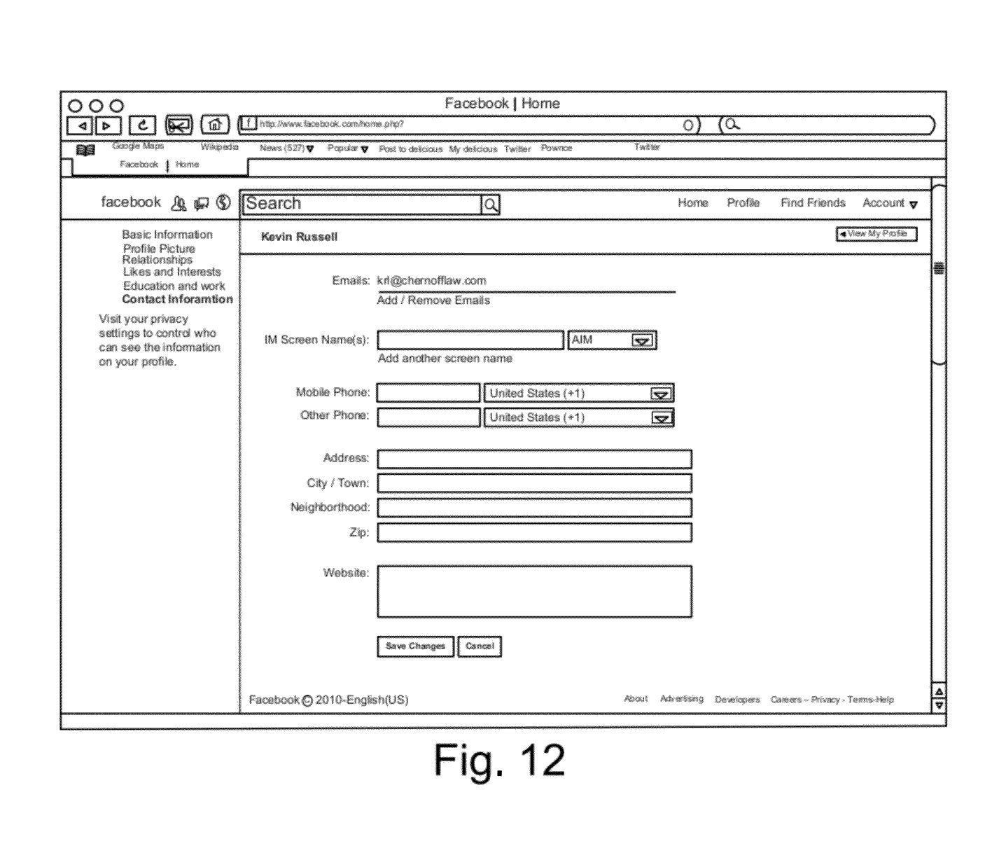

Referring to FIG. 12, a Facebook account may include: Contact Information that includes (1) email(s), (2) instant messaging screen name, (3) mobile phone, (4) other phone, (5) address, (6) city/town, (7) neighborhood, (8) zip, and (9) website.

With some or all of this information being provided, the human-centric social networking Facebook service (and other human-centric social networking services) generally provides sufficient information to relatively accurately identify the user. In addition, since the network of people connected to the user's Facebook account typically includes primarily friends there is little, if any, reason to remain primarily anonymous. Also, in most cases the number of friends that may view and/or have access to the Facebook page is controlled by the user.

While the sharing of reading experiences using the human-central social network is desirable, it is also desirable to include the capability of sharing reading experiences with a book-centric social network. A book-centric social network is generally created in an ad-hoc manner around the content being read by a group of people. When the reader starts reading a book, a magazine, a newspaper, or otherwise, the reader may be automatically signed up with an appropriate book-centric social network for that content. The readers, the author, the publisher, and others, who are reading or otherwise referring to a particular eBook (or other digital content) may interact with one another through the reader 100. The interaction since it is centered on a particular eBook (or other digital content or type of content) will tend to be related to the digital content.

Users can access both human-centric social networks and book-centric social networks on e-book readers, traditional personal computers, smart phones, or any network-capable device. The underlying network service preferably stores substantially all the information for a user and make it accessible anywhere and on any devices. This helps to provide a more seamless reading experience across multiple devices.

The book-centric social network generally has less personal information being shared among the different users since the focus is on the digital content instead. While some personal information may be shared, such as in the form of a limited profile, the personal information is typically of a more limited nature than for human-centric social networks. The book-centric social network may be defined as including primarily readers of a particular eBook, or other particular digital content. The book-centric social network may be defined as including a selection of eBooks (or other digital content) such as books listed on a book club. The user may join that particular book club or otherwise the content being read is a part of one or more book clubs which the user may join or automatically be a part of for sharing.

The book-centric social networks may likewise be dynamically generated and dynamically modified over time. For example, the New York Times best seller list may be a book-centric social network that changes on a periodic basis, such as weekly. Also, the book-centric social networks may be created in response to current events, such as books that relate to the 2010 soccer world cup or books about United States presidential elections. Frequently, such books attract heightened interest shortly before, during, and shortly after the event.

The book-centric social networks may likewise be primarily defined in terms of specific genres, such as for example, historical romances, golf, tennis, history, westerns, romance, horror, adventure, Wuxia, mystery, children's literature, poetry, etc. The book-centric social networks may likewise be primarily defined in terms of authors of books, such as for example, John Grisham, Agatha Christie, J. K. Rowling, and Jin Yong.

The readers may sign up, otherwise join, or automatically be joined, to many different book-central social networks, such as for example, book clubs, mystery, and golf. Readers may likewise discontinue their membership with any particular book-centric social network, as desired. The particular book-centric social networks are preferably automatically selected for eBook content where the book-centric social network may be identified with some certainty (such as genres, author, title, etc.) or otherwise groups that the user identifies as being of interest (such as book clubs).

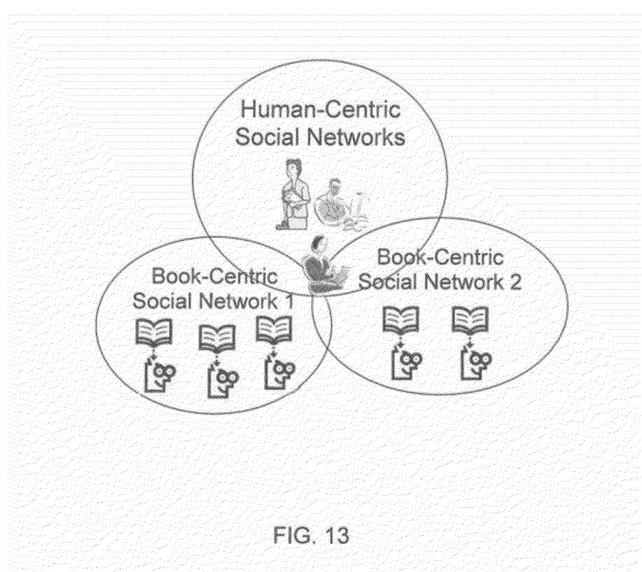

Referring to FIG. 13, the intersection between human-centric and book centric social networks is illustrated. Each user may be a member of one or more human-centric social networks. While reading an eBook (or other digital content) the user may likewise become a member of one or more book-centric social networks. The user may likewise be actively reading or otherwise multiple eBooks (or other digital content) and be a member of multiple book-centric social networks. Further, the user may be a member of multiple associated different human-centric social networks and/or have multiple accounts on a particular human-centric social network(s), all of which may be accessible by the reader 100.

The eBook reader is capable of sending and receiving information to both the applicable human-centric social networks and/or the applicable book-centric social networks. In one embodiment, the reader 100 may receive status updates from the human-centric social network(s) and process this information. Based upon the processed information, the reader 100 may provide suggestions to the reader of potential content that the reader may be potentially interested in. Since the user's friends tend to have similar likes and desires to the user, the processed information tends to be relevant to potential content the user may be interested in. For example, the device may show the user the most popular book that is currently being read by his friends; the least popular book that is being read by his friends; or a distribution of the books such as the 3 more popular books currently being read and the 3 least popular books currently being read. The time period for such an analysis may be those “currently” being read or otherwise having been at least partially read or accessed during a previous defined time period.

The suggested content list may be computed based upon several criteria that the readers may specify. Such criteria may include one or more of the following: (1) the previous reading history of the user; (2) the previous reading history of the user's friends; (3) how likely the user wants to explore the genre or categories of the content; (4) how likely the user wants to stay synchronized with friends.

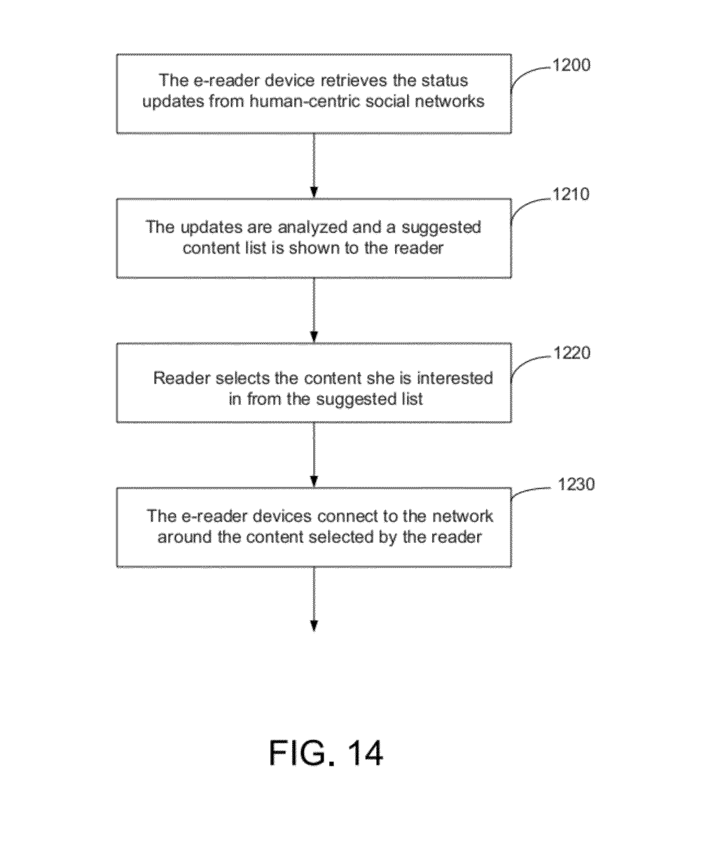

Referring to FIG. 14, one exemplary process of using a human-centric social network to suggest content and suggesting additional book-centric networks is illustrated. The reader retrieves the status updates from the associated human-centric social networks 1200. The status updates are analyzed and a suggested content list is provided to the reader 1210. The reader then selects from the suggested content list those items of interest 1220. The reader then connects to the book-centric social network providing information from different book-centric groups that would likely be of interest to the reader 1230.

Users may likewise choose to share their reading activities on the human-centric social networks. The activities may include, for example, the current book title being read, the current chapter being read, their current opinion on the content being read, and interaction between users of the same or similar content. While the current opinion on the content is likely manually entered by the user, the book title, and/or the current chapter would be known by the reader 100 and thus could be automatically posted to the human-centric social network upon the occurrence of an event. The event may include, for example, the user opening a document in their reader, the user selecting a menu option automatically posting such information, the user closing a document in their reader, or otherwise.

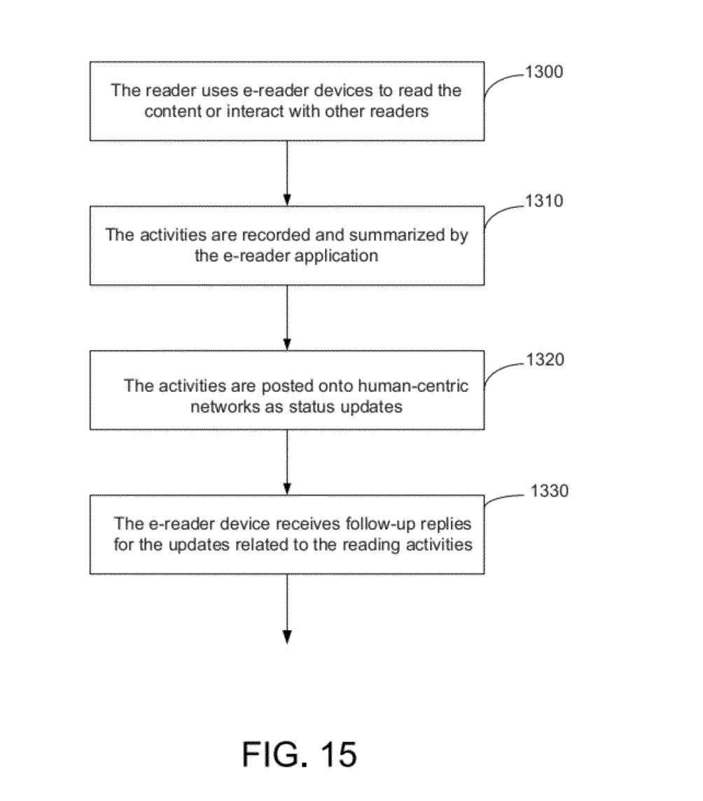

Referring to FIG. 15, the posting of reading activities to the human-centric social network may include the user's content and interacting with other users 1300. The activities may be recorded and summarized by the reader 1310. The activities may then be posted onto the human-centric social network(s) as status updates 1320. The reader 100 may receive follow-up replies for the updates as being related to the previously posted updates 1330.

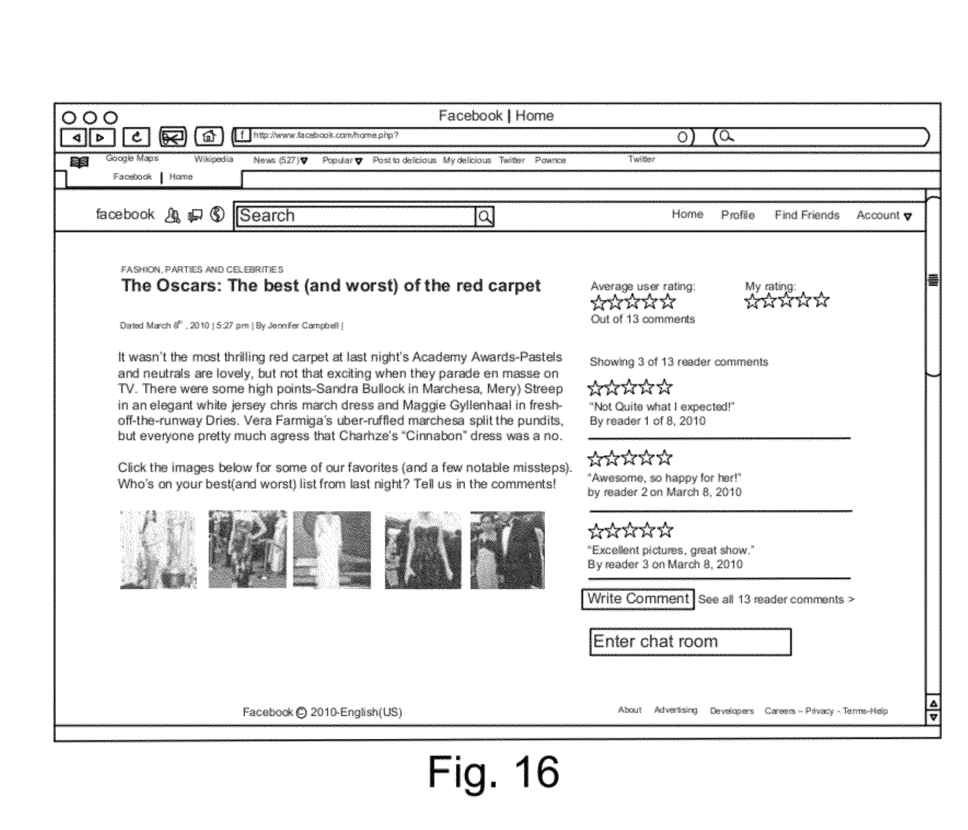

Many programs may be implemented by the reader 100 to enhance the user's interaction with the book-centric social networks. Referring to FIG. 16, one program accessible from within the eBook reader application may be referred to as “content feedback integration”. The content feedback integration program provides an interface for the user to read a document and generate feedback for different parts of the document. The content feedback integration allows the author of the document and the moderator of the document to likewise provide feedback. The feedbacks may include, for example, comments, reference information, related links, voting, and ratings. The user can leave comments for a part of the document, see what the other user's say about the document, rate the document or the part of the document, and see the ratings provided by others. The users can also enter an associated chat room by selecting the “Enter Chat Room” icon and communicate with peers likewise reading the document in real time.

Readers may choose to rate the books that they are reading using a predetermined set of categories, e.g., “like it very much”; “best of the author”; “like it”; or “don't like it”. In this case, the reader will not only have access to the titles of the most popular books but also to the number of people (or a percentage thereof) who like it very much, who think that it is the best work of the author, who just like it, and who do not like it. This information provided by the user reflects the readers' feelings while and/or after reading of the content and it thus exceptionally relevant. In addition, this data tends to be more current and dynamically updated.

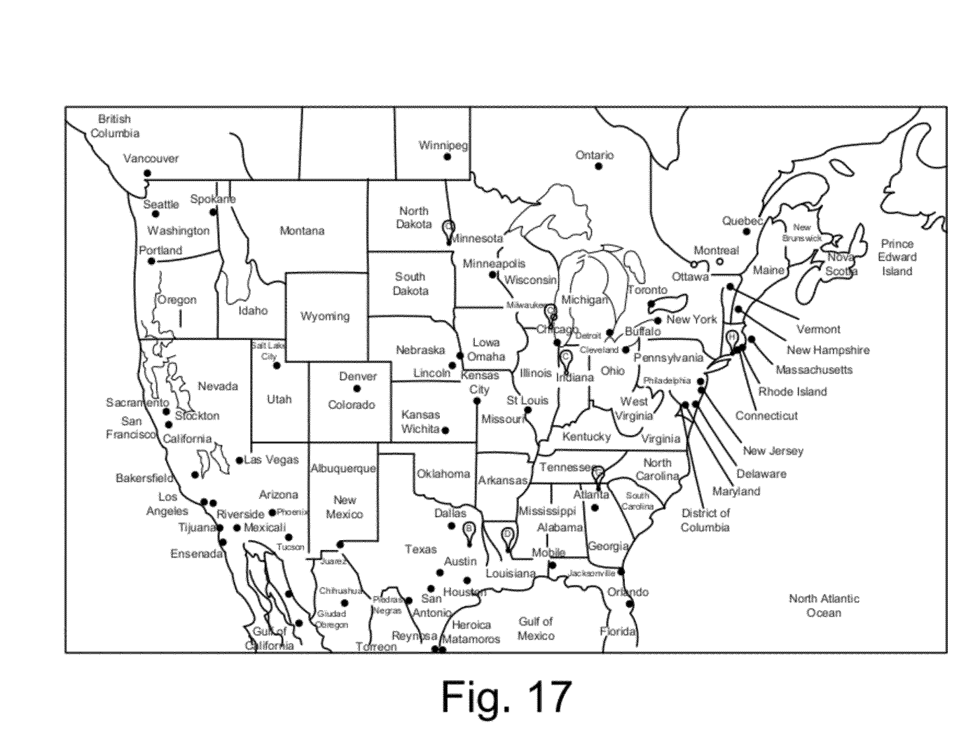

Referring to FIG. 17, another program accessible from within the eBook reader application may be referred to as “geo-mapping” which records and updates the physical locations of other readers around the world reading the same and/or similar content. The locations of other readers are identified on the map. The readers can view where other readers are physically located which increases a user's motivation in the document and/or the group. The readers' locations can be obtained by their Internet-protocol address of their Internet connection, global positioning receiver, information provided in their profile, or otherwise. Each reader's identity is preferably kept anonymous, so that one user does not know the particular identify of the other user.

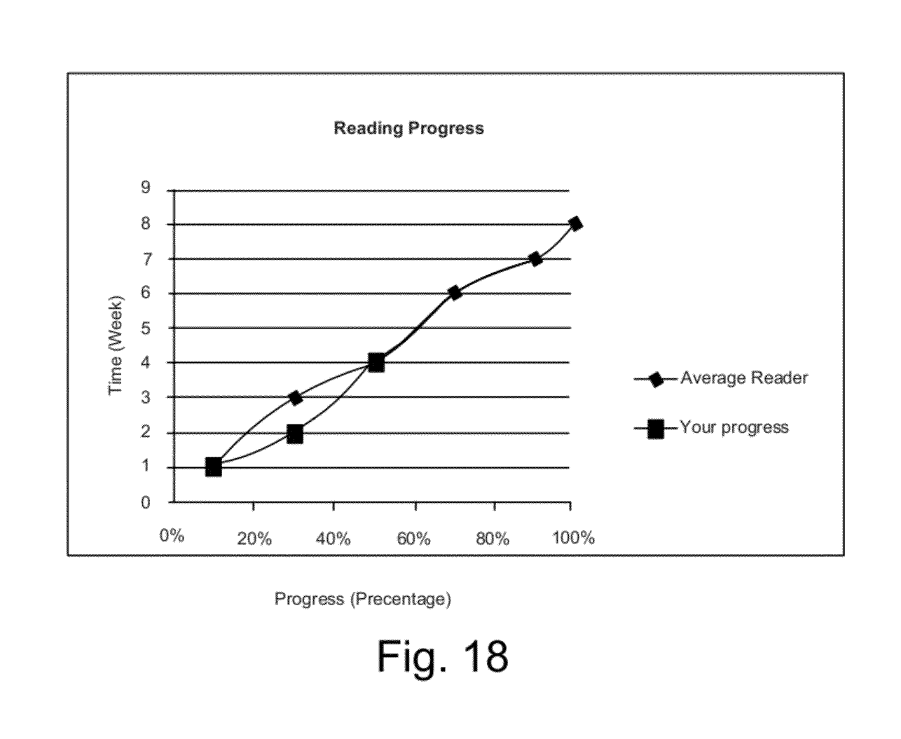

Referring to FIG. 18, another program accessible from within the eBook reader application may be referred to as a “reading progress tracker”. When a user starts reading a document, he can see the progress of other users reading the same document or otherwise in the same group. The progress may be illustrated, for example, as the current page number where other readers are looking at or the chapter number. The progress can also be the relative percentage of the page/chapter number over the total number of pages/chapters. The graphical representation of a users' progress as compared to others provided a feeling of connectedness to other users reading the same content or in the same group, and increases ones motivation to complete reading a document.

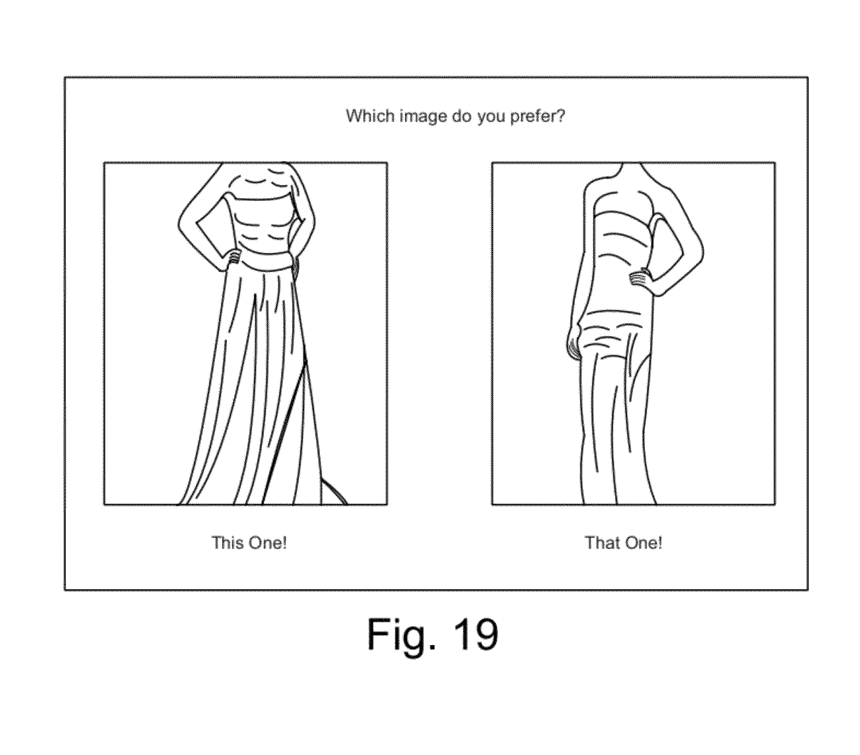

Referring to FIG. 19, another program accessible from within the eBook reader application may be referred to as a “reader's choice selection”. This application allows the readers to express their opinions on the document or any part of it and choose the best thing they like in the document. One embodiment is to generate a list of all items (e.g., articles/images/graphics) in the document and ask the reader to rank them. Another embodiment is to ask a pair of readers to exchange their opinions on the document by playing a game anonymously. As such, the embodiment shows the item pairs selected from the whole list and asks the users buddies to select the better one between the two. After the two readers make their choices, they will proceed to the next round. The pair which achieves highest consensus will win this game and could be given awards.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A system for reading electronic documents comprising:
(a) a portable electronic device having an integrated front facing display;
(b) an electronic document reading program operating on said electronic device suitable for the presentation of electronic documents on said display for reading by a user;
(c) said electronic document reading program including an option to selectively provide information to and receive information from a human-centric social networking service and a book-centric social networking service.

2. The system of claim 1 wherein said portable electronic device is relatively thin with said front facing display sized to be at least a majority of the front surface of said portable electronic device.

3. The system of claim 2 wherein said portable electronic device is a cellular phone.

4. The system of claim 1 wherein said front facing display includes a touch screen.

5. The system of claim 4 wherein an input keyboard is provided on said touch screen.

6. The system of claim 1 wherein said option is a provided using a menu.

7. The system of claim 1 wherein said electronic documents are presented in at least one of (1) a single page at a time, (2) a part of a single page at a time, (3) multiple pages at a time, (4) two pages at a time, and (5) in a scrollable manner.

8. The system of claim 1 wherein said electronic document reading program said provides information to said at least one of said human-centric social networking service and said book-centric social networking service by using a window into which text may be entered.

9. The system of claim 1 wherein said electronic document reading program said provides information to said at least one of said human-centric social networking service and said book-centric social networking service by using a window within an interface encompassing said electronic document reading program.

10. The system of claim 1 wherein said electronic document reading program said provides information to said at least one of said human-centric social networking service and said book-centric social networking service by using a window without fully obscuring said electronic document reading program on said display.

11. The system of claim 1 wherein said human-centric social networking service include the capability of including more personal information about a user than said book-centric social networking service.

12. The system of claim 1 wherein said human-centric social networking service include the capability of including more personal information about a user than said book-centric social networking service.

13. The system of claim 1 wherein users of said book-centric social networking service are generally anonymous.

14. The system of claim 1 wherein said book-centric social networking service and said human-centric social networking service each include a different profile of the same user, wherein the profile associated with said user for said book-centric social networking service is the same independent of what device accesses said book-centric social networking service and wherein the profile associated with said user for said human-centric social networking service is the same independent of what device accesses said human-centric social networking service.

15. The system of claim 1 wherein users of said book-centric social networking service includes groups of books.

16. The system of claim 1 wherein users of said book-centric social networking service primarily includes readers of a digital content.

17. The system of claim 16 wherein said digital content is eBooks.

18. The system of claim 1 wherein users of said book-centric social networking service are automatically connected to an appropriate part of said book-centric social networking service based upon content being presented on said portable electronic device.

19. The system of claim 1 wherein content from said human-centric social networking service is used as the basis to provide content suggestions to a user of said portable electronic device.

20. The system of claim 1 wherein content provided to said human-centric social networking service is automatically provided based upon a user's use of said electronic document reading program.

21. The system of claim 1 wherein content provided to said book-centric social networking service is automatically provided based upon a user's use of said electronic document reading program.

22. The system of claim 1 wherein content provided to said book-centric social networking service includes the capability of providing comments on portions of a book that are identified together with said comments.

23. The system of claim 1 wherein content provided to said book-centric social networking service relates to a user's liking of a particular book after reading said book on said portable electronic device.

24. The system of claim 1 wherein a map identifying the location of a plurality of other user's reading the same content as being read on said portable electronic device.

25. The system of claim 1 wherein a graph illustrates the reading progress of a plurality of other user's reading the same content as being read on said portable electronic device.
